(19) United States
(12) Patent Application Publication
(10) Pub. No.: US 2006/0083396 A1
(43) Pub. Date: Apr. 20, 2006

(54) Hand-held wireless speaker

(76) Inventor: Te-Wei Kung, Chai-Yi City (TW)

Correspondence Address: Te-Wei Kung, P.O. BOX 90, Tainan City, 70499, TW

(21) Appl. No.: 10/997,926

(22) Filed: Nov. 29, 2004

(30) Foreign Application Priority Data
Oct. 20, 2004 (TW) 093216689

(51) Int. Cl. H04R 1/02; H04R 9/06; H04B 5/00

(52) U.S. Cl. 381/334; 381/79

(57) ABSTRACT

A handheld wireless speaker comprises a body having a receiving chamber; a positioning seat installed within the receiving chamber. The body further has a battery chamber of receiving at least one battery. A sensor is assembled in the body. A volume control panel is assembled within the body. A plurality of buttons is installed on the volume control panel. The buttons is connected to the backboard of the body. An amplifier plate is assembled in the body. A wireless receiving plate and infrared receiving plate are assembled in the body. A mask cover is installed in the front wall of the body. The mask cover has a light filtering mask. A net mask is installed on a wall of the mask cover. An inner surface of the mask cover is formed with a trumpet facing the net mask; and a CD player is assembled to a backboard of the body.

### BACKGROUND OF THE INVENTION

1. Field of the Invention

The present invention relates to a hand-held wireless speaker with the characters, such as small capacity, light-handy, huge output power and stable tone quality without any distortion.

2. Description of the Prior Art

According to the prior art, a wireless receiver sets in a casing of a speaker to transmit sound by a wireless microphone, transmitting amplified sound through a wireless receiver in a casing and a trumpet.

However, a speaker of prior arts uses two wireless microphones in a same time, this is because their sound bands are so close so that they are easy to interfere with each other to cause the transmitting sounds to interfere to each other, which is unpleasant to the ears.

At a further prior art, an infrared receiver of a sound box sets in a casing of a speaker by an infrared microphone to transmit sound, receiving sound by infrared receiver and exporting amplified sound through trumpet.

However, the same problem still exists in this kind of speaker. If two infrared microphones are used in the same times, they induce sound interference because of the wireless microphone transmitting the same sound. Furthermore, the prior art speakers have great volumes so that it is difficult to be carried and a great space is necessary for storing them. Furthermore, if the volume is great, distortion will induce.

### SUMMARY OF THE INVENTION

Accordingly, the primary object of the present invention is to provide a hand-held wireless speaker with the characters, such as small capacity, light-handy, huge output power and stable tone quality without any distortion.

To achieve above objects, the present invention provides a wireless handheld speaker comprises a body having a receiving chamber; a positioning seat installed within the receiving chamber. The body further has a battery chamber of receiving at least one battery. A sensor is assembled in the body. A volume control panel is assembled within the body. A plurality of buttons is installed on the volume control panel. The buttons is connected to the backboard of the body. An amplifier plate is assembled in the body. A wireless receiving plate and infrared receiving plate are assembled in the body. A mask cover is installed in the front wall of the body. The mask cover has a light filtering mask. A net mask is installed on a wall of the mask cover. An inner surface of the mask cover is formed with a trumpet facing the net mask; and a CD player is assembled to a backboard of the body.

The various objects and advantages of the present invention will be more readily understood from the following detailed description when read in conjunction with the appended drawing.

### BRIEF DESCRIPTION OF DRAWINGS

FIG. 1 is an exploded perspective view of the present invention.

FIG. 2 is a front perspective view showing components of the present invention.

FIG. 3 is a rear perspective view showing the components of the present invention.

FIG. 4 is an assembled perspective view of the present invention.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same.

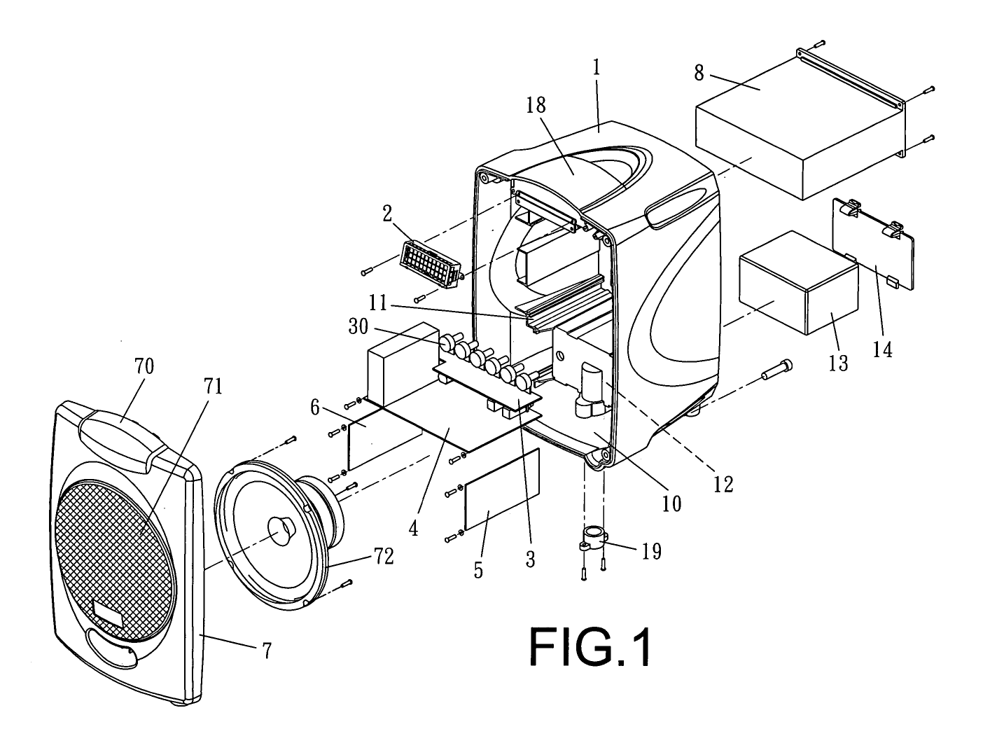

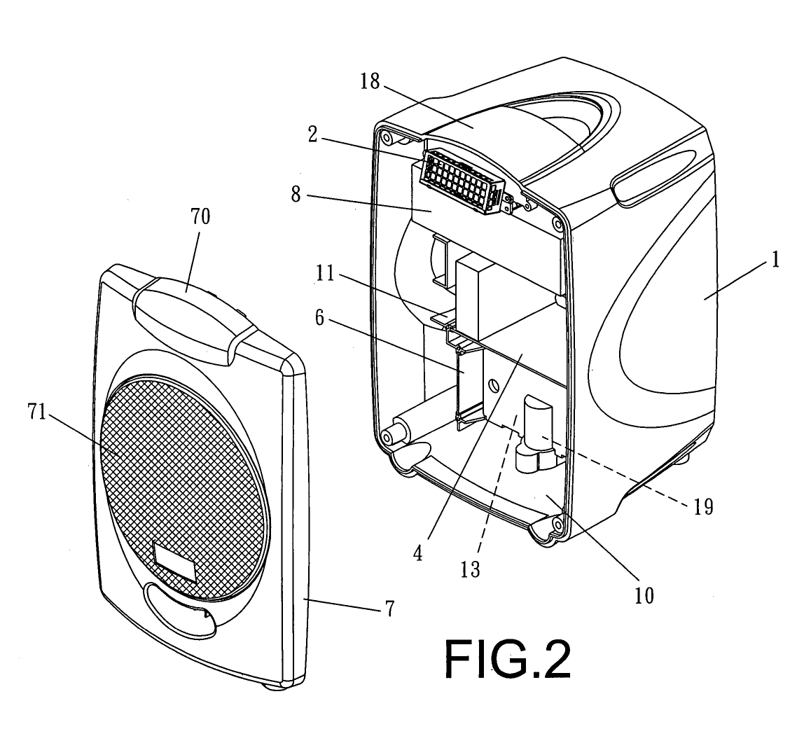

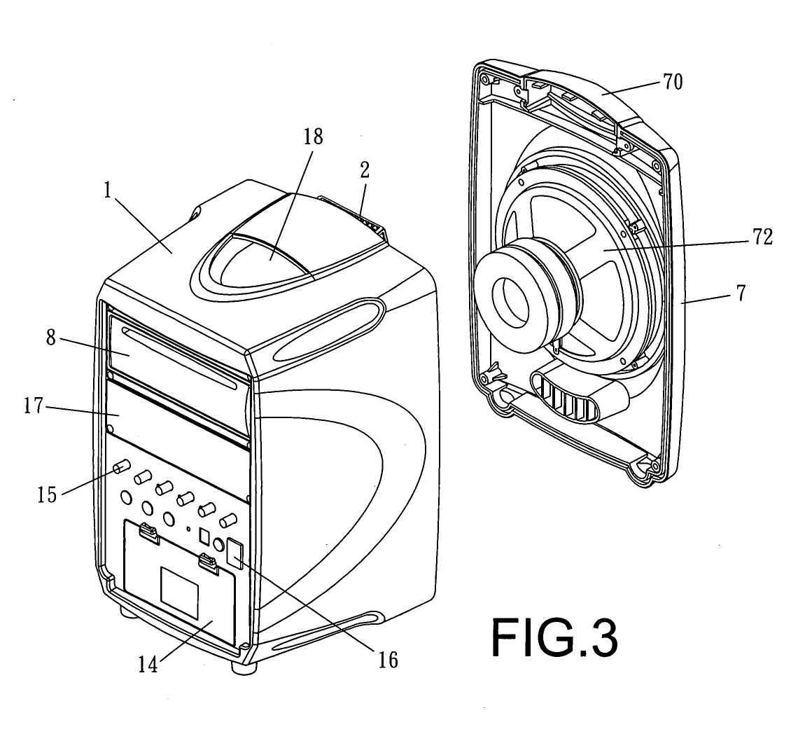

At first, referring to FIGS. 1, 2 and 3, the present invention includes a body 1. The body 1 has a receiving chamber 10. A positioning seat 11 is disposed in the receiving chamber 10.

The body 1 is installed with a battery chamber 12. A battery 13 is disposed in the battery chamber.

A battery cover 14 is mounted on a backboard of the body 1 for covering the battery chamber 12.

A power switch 16 and a plurality of buttons 15 are mounted on the backboard of then body 1.

A CD panel 17 is mounted on the backboard of the body 1.

A handle 18 is mounted on the body 1.

At least one support seat 19 is mounted under the bottom of the body 1.

A sensor 2 is assembled in front of a handle 18 of the body 1.

A volume control panel 3 is assembled in the body 1. The volume control panel 3 has several adjusters 30 which are comprised of several buttons 15 on the backboard of the body 1.

An amplifier plate 4 is disposed in the body 1.

A wireless receiver plate 5 and an infrared receiver plate 6 are disposed in the body 1.

A mask cover 7 mounted with a light filter mask 70 is set on the front board of the body 1.

A net mask 71 is disposed on the board of mask cover 7. In an opposite position of net mask 71 is mounted with and aligned with a trumpet in the inside of mask cover 7.

A CD player 8 is installed on the backboard of the body 1.

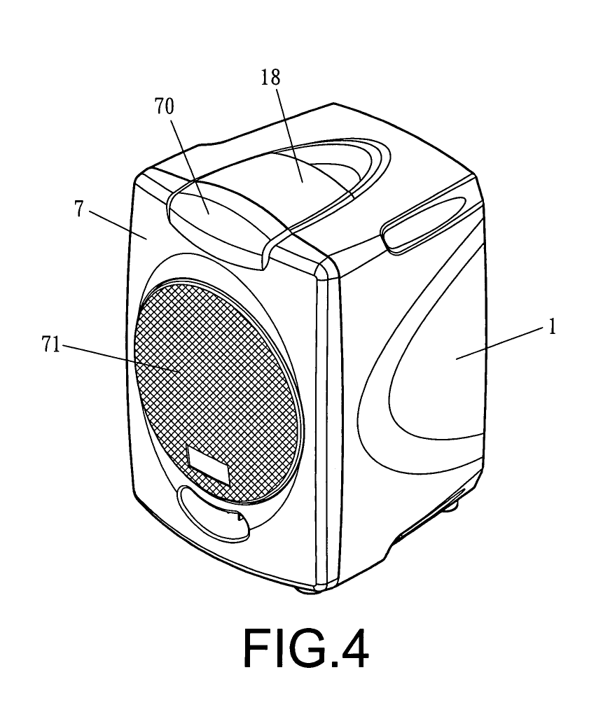

As assembling, referring to FIGS. 1, 2, 3 and 4, firstly, the sensor 2 is mounted in front of the handle 18 in the receiving chamber 10 of the body 1.

Then the volume control panel 3, amplifier plate 4, wireless receiver plate 5 and infrared receiver plate 6 are all assembled in the body 1.

The positioning seat 11 is used to situate the body 1 correctly. The trump 12 is mounted on the inside of the mask cover 7 facing the net mask 71 straight. The battery 13 is assembled in the battery chamber 12 contained within body 1.

Finally, the assembly is finished by covering the battery cover 14 and set the CD player 8 on the backboard of the body 1.

As using the design, the wireless receiver plate 5 is actuated by only one simple step to turn on the power switch 16, the sound can be transmitted by wireless microphone.

The sound can be received by wireless receiver plate 5 within the body 1. Beside, the sound volume and sound effect can be adjusted by the button 15 on the backboard of the body 1 by pushing forward adjusters 30 on the volume control panel 3.

If it is desired to use the infrared microphone, it is only necessary to switch on the infrared receiver plate 6, then sound can be transmitted by the infrared microphone. The sound is transmitted through light filter mask 70 of the mask cover 7 to actuate the sensor 2, and then received by infrared receiver plate 6. Furthermore, the sound is transmitted by amplifier plate 4, then amplifying received sound outputted by the trump 72.

The battery 13 contained within body 1 can supply power directly without any external power source. The design is convenient for carry out. The present invention serves to receive sound from the wireless microphone and infrared microphone. Then the sound is amplified by the trumpet 72 and then are emitted by the amplifier 4. Thereby the output power is great with a stable sound quality and without any distortion. Thereby the output frequencies of the wireless microphone and infrared microphone are different from one another and thus the frequencies of the two will not interfere with one another. Thus the sound can be transmitted bidirectionally with any interference. Thereby the present invention can be realized in a compact volume of a size of A4.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A handheld wireless speaker comprising:
a body having a receiving chamber; a positioning seat being installed within the receiving chamber; the body further having a battery chamber; at least one battery being mounted in the battery chamber; a battery cover being installed on the backboard of the body for covering the battery chamber; a handle being installed on the body; at least one support seat being installed on a bottom of the body;
a sensor assembled in front of the handle of the body;
a volume control panel assembled within the body; a plurality of buttons being installed on the volume control panel; the buttons being connected to the backboard of the body;
an amplifier plate assembled in the body;
a wireless receiving plate and infrared receiving plate being assembled in the body;
a mask cover installed in the front wall of the body; the mask cover having a light filtering mask; a net mask being installed on a wall of the mask cover; an inner surface of the mask cover formed installed with a trumpet facing the net mask; and,
a CD player assembled to a backboard of the body.
